(19) United States
(12) Patent Application Publication
(10) Pub. No.: US 2007/0040974 A1
(43) Pub. Date: Feb. 22, 2007

(54) LIQUID CRYSTAL DISPLAY PANEL

(76) Inventors: Kisako Ninomiya, Fukaya-shi (JP); Norihiro Yoshida, Fukaya-shi (JP); Takeshi Yamaguchi, Kumagaya-shi (JP); Yasushi Kawata, Ageo-shi (JP); Yuuzo Hisatake, Fukaya-shi (JP); Akio Murayama, Fukaya-shi (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 11/464,937

(22) Filed: Aug. 16, 2006

(30) Foreign Application Priority Data
Aug. 18, 2005 (JP) 2005-237619

(51) Int. Cl. G02F 1/1337

(52) U.S. Cl. 349/129

(57) ABSTRACT

A liquid crystal display panel comprising a first electrode substrate, a second electrode substrate, and a liquid crystal layer which contains a liquid crystal composition having negative dielectric anisotropy and which is interposed between the first electrode substrate and the second electrode substrate. The first electrode substrate has pixel electrodes which are spaced apart by blank areas BL and a plurality of spacers which are arranged in the blank areas BL and set the first and second electrode substrates apart from each other by a predetermined distance. The second electrode substrate has ridge-shaped projections and flat parts. The projections are opposed to the pixel electrodes and control an inclination of an electric field applied between the first and second electrode substrates. The flat parts are integrally formed with the ridge-shaped projections and wholly contact tops of the spacers.

### CROSS-REFERENCE TO RELATED APPLICATIONS

This application is based upon and claims the benefit of priority from prior Japanese Patent Application No. 2005-237619, filed Aug. 18, 2005, the entire contents of which are incorporated herein by reference.

### BACKGROUND OF THE INVENTION

1. Field of the Invention

This invention relates to a liquid crystal display panel that operates in multi-domain type VAN mode. More particularly, the invention relates to a liquid crystal display panel that has active elements such as TFTs.

2. Description of the Related Art

Displays having a liquid crystal display panel are light, thin and consumes only a little power. They are therefore used in various apparatuses, such OA apparatuses, information terminals, clocks, and television receivers. Particularly, liquid crystal display panels, each having TFTs, fast respond to input signals. This is why they are used in monitors designed for use in portable television receivers, computers and the like and which display various items of information.

In recent years, information is distributed and used in an increasing amount. It is therefore demanded that liquid crystal displays should display information at high resolution and should fast respond to input signals. To display information at high resolution, each liquid crystal display panel have more and more TFTs included in its TFT array. To respond to the input signals faster, each liquid crystal display panel may be of OCB type, VAN type, HAN type, or π-arrangement type, which uses nematic liquid crystal, or of surface-stabilized ferroelectric liquid crystal (SSFLC) type or anti-ferroelectric liquid crystal (AFLC) type, which uses smectic liquid crystal.

The liquid crystal display panel of VAN orientation type responds to input signals faster than the conventional twist nematic type (TN) type. In addition, it can be manufactured by using perpendicular orientation, not performing rubbing orientation that may result in undesirable event such as electrostatic damage. The VAN orientation type has therefore been attracting attention in recent years.

In the VAN type panel, it is relatively easy to compensate for the angle of visibility. Therefore, the VAN type panel can have a larger angle of visibility than the multi-domain type VAN type panel. To achieve orientation division, ridge-shaped projections or pixel electrodes having slits are formed on one substrate or both substrates in most cases.

A liquid crystal display panel that operates in MVA mode is shown in FIG. 10. As FIG. 10 shows, pixel electrodes 151, each having slits SL, are provided on an array substrate 101. Ridge-shaped projections 30 are formed on a common electrode 22 that is provided on a counter substrate 102.

The array substrate 101 and the counter substrate 102 are spaced apart by a specific distance by spacers (not shown) as in most liquid crystal display panels. In recent years, it has been proposed that projections be provided, as spacers, on the wires arranged around the pixel electrodes. It has been proposed that such projections be formed by performing, for example, photolithography on transparent resist.

Nematic liquid crystal material that exhibits negative dielectric anisotropy may be used to form a liquid crystal layer. In this case, an electric field inclines outside the slits SL of each pixel electrode 151, due to the electric-field dispersion effect. Consequently, liquid crystal molecules 190A incline in the slits SL.

At the counter substrate 102, the liquid crystal molecules 190A incline outside the ridge-shaped projections 30, because of the shape of these projections. Orientation division can be well achieved if the array substrate 101 and counter substrate 102 are so arranged that the liquid crystal molecules 190A may incline in the same direction.

The liquid crystal layer 190 can be divided two or more domains if anisotropy is imparted to the pattern of slits and the pattern of ridge-shaped projections. Generally, it is desired that displays should have a large angle of visibility so that any image displayed may be seen from the left, from the right, from above and from below. Therefore, the liquid crystal layer 190 should be arranged in each pixel or each region of the layer 190, in such a specific pattern that the molecules 190A exhibit anisotropy to the above-mentioned four directions.

Here arises a problem. In most cases, slits SL divide an ITO electrode into pixel electrode 151, which are almost rectangular strips. The liquid crystal molecules 190A at the end parts of each pixel electrode 151 are inevitably oriented in directions different from the design directions.

Such a liquid crystal display panel as shown in FIG. 11 has been proposed (see Jpn. Pat. Appln. KOKAI Publication No. 2001-235751). In this panel, the slits SL of each pixel electrode 151 and the ridge-shaped projections 30 incline at approximately 45° to the sides of the array substrate 101. Further, some of the slits SL exhibits anisotropy of approximately 90° with respect to the other slits SL, and some of the ridge-shaped projections 30 exhibits anisotropy of approximately 90° with respect to the other ridge-shaped projections 30. Hereinafter, this pixel-division pattern will be referred as “less-than sign pattern”, because it looks like “<”.

Most liquid crystal elements 190A in each pixel are oriented in the four directions (FIG. 11) as designed, thanks to the electric-field dispersion effect mentioned above. However, the liquid crystal molecules 190B existing, for example, near ends of the pixel are oriented in directions different from those designed, due to electric-field dispersion effect. This orientation disorder, i.e., reverse orientation, is visually recognized. The orientation disorder may reduce the transmittance and may increase image roughness, thus lowering the quality of images in some cases.

To cope with the reverse orientation, it has been proposed that inclination correction parts 30B be laid on the end parts of each pixel electrode as shown in FIG. 12. The inclination correction parts 30B so provided can cancel out the electric-field dispersion effect that may cause reverse orientation. FIG. 12 shows the pixel-division pattern, i.e., less-than sign pattern, which includes the inclination correction parts 30B laid on the end parts of each pixel electrode.

This less-than sign pattern has a problem. The uniformity of cell-gap of the liquid crystal display panel may decrease if some of the inclination correction parts 30B interfere with the spacers.

In the liquid crystal display panel in which spacers are formed on, particularly, the array substrate 101, the array substrate 101 and the counter substrate 102 are displaced from each other while they are being bonded together. If the spacers contact the inclination correction part 30B, they will ride onto the inclination correction parts 30B. If this takes place, the gap between the array substrate 101 and the counter substrate 102 may became greater than the target value.

How much the spacers interfere with the inclination correction part 30B depends on the mutual displacement of the substrates 101 and 102 and the direction of this displacement. It is therefore difficult to control the cell-gap to the target value. As a result, the uniformity of the cell-gap may greatly decrease in some cases.

To prevent a great decrease in the uniformity of cell-gap, the distance between the spacers and the inclination correction parts 30B may be set to a value large enough to compensate for the mutual displacement of the substrates 101 and 102. If this distance is so large, however, the design of the spacer and inclination correction parts 30B will be restricted.

If the spacers are reduced in size, they will be less readily processed and the counter substrate 102 may more likely warp when pressed with a finger. If the inclination correction parts 30B are made narrower, they may protrude from the end parts of the pixel electrodes 151, inevitably resulting in reverse orientation.

This invention has been made in view of the foregoing. The invention provides an inexpensive liquid crystal display panel in which ridge-shaped projections do not interfere with spacers, which has a large angle of visibility, a sufficient cell-gap uniformity, no surface roughness, and which can therefore high-quality images.

### BRIEF SUMMARY OF THE INVENTION

A liquid crystal display panel according to this invention comprises: a first electrode substrate; a second electrode substrate; and a liquid crystal layer which contains a liquid crystal composition having negative dielectric anisotropy and which is interposed between the first electrode substrate and the second electrode substrate. The first electrode substrate has a plurality of pixel electrodes, which are spaced apart by blank areas, and a plurality of spacers which are arranged in the blank areas and which set the first and second electrode substrates apart from each other by a predetermined distance. The second electrode substrate has a plurality of ridge-shaped projections which are opposed to said plurality of pixel electrodes and which control a inclination of an electric field applied between the first and second electrode substrates, and flat parts which are integrally formed with the ridge-shaped projections and which wholly contact tops of the spacers.

In the present invention, the ridge-shaped projections are prevented from the spacers. The invention can therefore provide an inexpensive liquid crystal display panel which has a large angle of visibility, high cell-gap uniformity and no surface roughness, and which can therefore display high-quality images.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a perspective view schematically showing a liquid crystal display panel according to a first embodiment of the present invention;

FIG. 2 is a plan view showing the display section of the liquid crystal display panel of FIG. 1.

FIG. 3 is a plan view depicting the pixel section of the liquid crystal display panel shown in FIG. 1;

FIG. 4 is a sectional view of the pixel section shown in FIG. 3.

FIG. 5 is a plan view depicting the pixel section of a liquid crystal display panel according to a second embodiment of the invention;

FIG. 6 is a sectional view of the pixel section shown in FIG. 5;

FIG. 7 is a table showing the results of evaluating the liquid crystal display panels according to the first and second embodiments of this invention;

FIG. 8 is a plan view of the pixel section of a liquid crystal display panel according to Comparative Example 1;

FIG. 9 is a sectional view of the pixel section shown in FIG. 8;

FIG. 10 is a sectional view schematically showing a liquid crystal display panel that operates in MVA type;

FIG. 11 is a plan view depicting the pixel section of the liquid crystal display panel that operates in MVA type; and

FIG. 12 is a plan view showing the pixel section of another liquid crystal display panel that operates in MVA type.

### DETAILED DESCRIPTION OF THE INVENTION

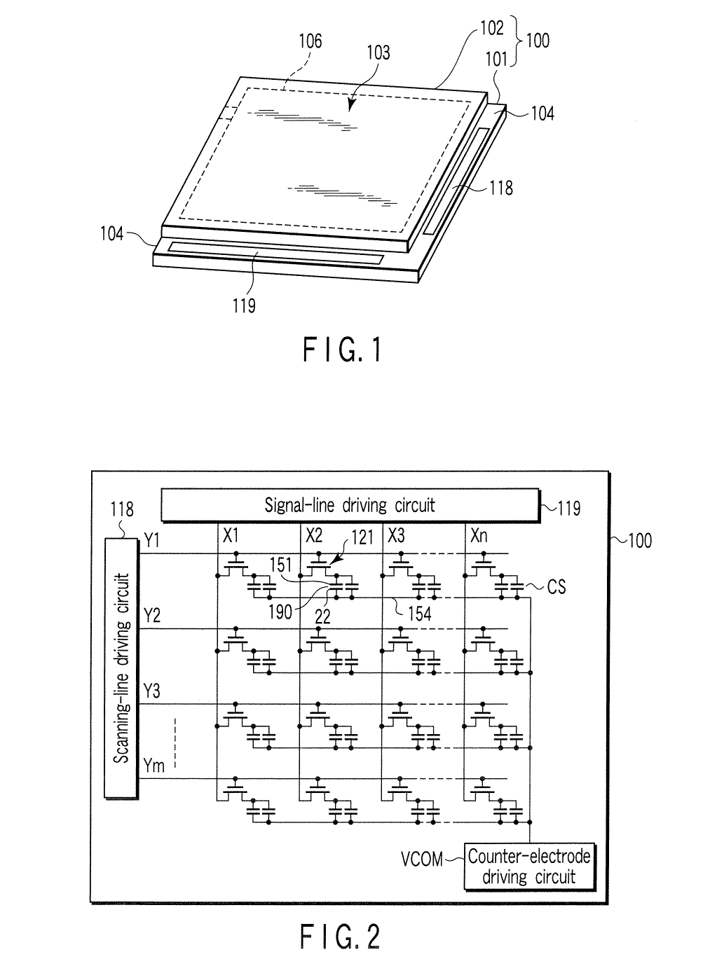

A liquid crystal display panel 100 according to a first embodiment of this invention will be described, with reference to the accompanying drawings. The panel 100 is, for example, an active-matrix liquid crystal display panel that operates in MVA mode. As shown in FIG. 1, the liquid crystal display panel 100 has an array substrate 101, a counter substrate 102, and a liquid crystal layer 190. The counter substrate 102 is opposed to the array substrate 101. The liquid crystal layer 190 is interposed between the array substrate 101 and the counter substrate 102.

Liquid crystal display panel 100 has a display section 103. The section 103 has a plurality of pixels PX, which are arranged in rows and columns, forming a matrix. Therefore, the display section 103 can display images. The section 103 is formed in a region that is surrounded by sealing frame 106. The sealing frame 106 is interposed between the array substrate 101 and the counter substrate 102. The array substrate 101 has edge parts 104 that lie outside the sealing frame 106. The liquid crystal layer 190 is made of liquid crystal composition that exhibits negative dielectric anisotropy.

As shown in FIG. 2, the array substrate 101 has m×n pixel electrodes 151, m scanning lines Y (Y1 to Ym), and n signal lines X (X1 to Xn). The pixel electrodes 151 are provided for pixels PX, respectively, which are arranged in m rows and n columns in the display section 103. The scanning lines Y (Y1 to Ym) extend along the columns of pixel electrodes 151. The signal lines X (X1 to Xn) extending along the columns of pixel electrode 151. The array substrate 101 further has m auxiliary capacity line 154, which extend along the rows of pixel electrode 151.

The scanning lines Y intersect with the signal lines X, substantially at right angles. The auxiliary capacity lines 154 are set to counter potential VCOM of a specific value, which is applied from a counter-electrode drive circuit. Each auxiliary capacity line 154 is capacity-coupled to the pixel electrodes 151 of the corresponding row, constituting auxiliary capacitance Cs.

On the array substrate 101, thin-film transistors (hereinafter referred to as TFTs) 121 are arranged. Each TFT 121 is connected, as switching element, to the corresponding pixel electrode 151 and is positioned near an intersection of one scanning line Y and one signal line X. Each TFT 121 is connected to the corresponding scanning line Y and the corresponding signal line X and is turned when a drive voltage is applied to it from the scanning line Y. It receives a signal voltage from the signal line X and applies the signal voltage to the corresponding pixel electrode 151.

The array substrate 101 further has a scanning-line driving circuit 118, a signal-line driving circuit 119, and the like, in the edge parts 104. The scanning-line driving circuit 118 drives the scanning lines Y. The signal-line driving circuit 119 drives the signal lines 118.

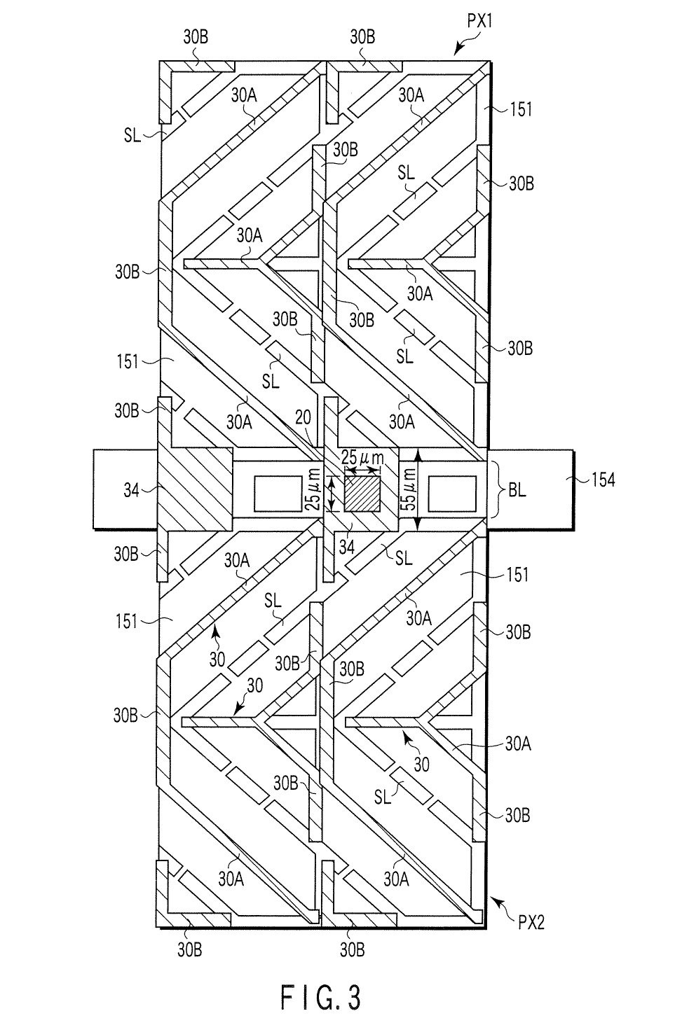

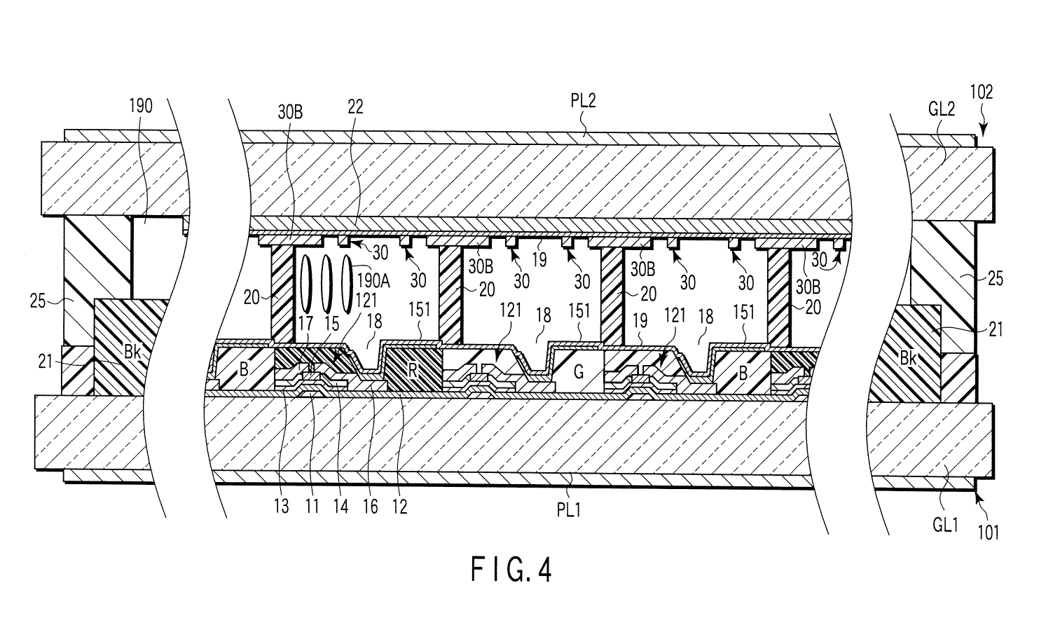

FIG. 3 shows is a plan view showing the pixel section of the liquid crystal display panel 100. FIG. 4 is a sectional view of the pixel section. As shown in FIGS. 3 and 4, a light-transmitting insulating substrate GL1, such as a glass substrate, is formed on the array substrate 101. The TFTs 121 are formed on the substrate GL1. The TFTs 121 are covered with a color filter layer CF. The color filter layer CF comprises a plurality of coloring layers, which are repeatedly arranged in the along the rows of pixel electrodes 151 and along the columns thereof. The three coloring layers of different colors, i.e., red filter layer R, green filter layer G and blue filter layer, are provided for each pixel electrode 151.

Each pixel electrode 151 is spaced by a blank area BL from an adjacent pixel electrode 151. Each pixel electrode 151 has slits SL. The slits SL incline at 45° to the array substrate 101 or to the end parts of pixel electrode 151. The slits SL are arranged so that each may have anisotropy different from that of the next one.

Spacers 20 are formed in a blank area on array substrate 101 and therefore located between the pixel electrodes 151. The spacer 20 are shaped like a pillar and made of the same material as a shielding layer arranged in a frame area 21, which surrounds the pixel electrodes 151. The spacers 20 keep the counter substrate 102 spaced from the array substrate 101, providing a uniform gap between the substrates 101 and 102.

On the counter substrate 102, a light-transmitting insulating substrate GL2, such as a glass substrate, is provided. A common electrode 22 is formed on the substrate GL2. The common electrode 22 is made of transparent, electrically conductive material such as ITO and is covered with an orientation film 19.

The common electrode 22 faces all the pixel electrodes 151 arranged on the array substrate 101. The orientation film 19 orientates the liquid crystal molecules 190A contained in the liquid crystal composition forming the liquid crystal layer 190, almost perpendicular to the counter substrate 102.

The counter substrate 102 has a major surface that faces the pixel electrodes 151. A plurality of ridge-shaped projections 30 are formed on this major surface. Each ridge-shaped projection 30 has an inclination control part 30A and an inclination correction part 30B. The inclination control part 30A extends substantially parallel to the slits SL. The inclination correction part 30B faces one end part of one pixel electrode 151. That is, in each pixel PX, the slits SL and ridge-shaped projections 30 are arranged, forming less-than sign patterns. Thus, four domains are formed, which differ in orientation by substantially 90°.

The counter substrate 102 has superposed parts 34 (flat parts) formed in the blank area BL between the adjacent pixel electrodes 151. The superposed parts 34 have been formed by broadening the inclination correction parts 30B provided at the outer edges of two adjacent pixel electrodes 151. That is, the superposed parts 34 are integrally formed with the inclination correction parts 30B that formed an outer edge of pixel electrodes 151 that is adjacent to the blank area BL.

The slits SL and the inclination control part 30A control the inclination to the electric field applied between the array substrate 101 and the counter substrate 102. The inclination correction part 30B corrects the inclination to the electric field.

Polarizing plates PL1 and PL2 are bonded to those surfaces of the insulating substrates GL1 and GL2, respectively, which face away from the liquid crystal layer 190.

In this embodiment, the width of superposed part 34 is about 55 μm. The superposed part 34 lies over the adjacent pixels PX1 and PX2, overlapping an auxiliary capacity line 154 (about 40 μm wide). The size of each spacer 20 is 25 μm×25 μm. All upper part of the spacer 20 contacts the superposed part 34 once after the display panel 100 is assembled. The slits SL have a width of 10 μm. Any two adjacent pixel electrodes are spaced apart by a distance of 6 μm. The ridge-shaped projections 30 for orientation division have a width of 8 μm.

The liquid crystal display panel 100 has a color-filter-on-array (COA) structure, in which the color filter layers CF is formed on the array substrate 101, together with the array of TFTs 121 and the array of pixel electrodes 151. In the COA structure, the color filter layer CF and the counter substrate 102 need not be precisely aligned with no mutual displacement. This can simplify the manufacture of the display panel 100 and reduce the material cost thereof.

If the liquid crystal display panel 100 is a transmission type as mentioned above, it is desired, in view of transmittance desired and color desired, that the color filter layer CF be made of transparent resin, such as acrylic resin, epoxy system resin, and novolak resin.

A method of manufacturing the liquid crystal display panel 100 will be explained, with reference to FIG. 4. As in the process of forming active active-matrix elements, film forming and patterning are alternately repeated, thereby forming TFTs 121. Thereafter, other processes of ordinary type are performed to manufacture the liquid crystal display panel 100.

First, a molybdenum film is formed on the transparent substrate GL1, to a thickness of about 0.3 μm, by means of sputtering. Photolithography is performed, patterning the molybdenum film and forming scanning lines Y, auxiliary capacity lines 154, and source electrodes 11 extending from the scanning lines Y.

On the resulting structure, a film of silicon dioxide or silicon nitride is formed to a thickness of 0.15 μm, thus forming a gate insulating layer 12. A semiconductor layer 13 for TFTs 121 is formed on the gate insulating layer 12. On semiconductor layer 13, signal lines X, drain electrodes extending from the signal line X, and source electrodes are formed, which are made of aluminum and 0.3 μm thick, are formed, whereby TFTs 121 are formed.

Then, photosensitive resist in which red pigment is dispersed, is applied to the entire surface of the resulting structure, by using a spinner. The resist is dried for 10 minutes at about 90° C. The resist is exposed to light through a photomask, thus applying ultraviolet rays at a dose of about 200 mJ/cm², to only those parts of the resist which will be red coloring layers. Next, development is performed on the acquired structure for about 20 seconds, with 1 wt % aqueous solution of potassium hydroxide. The structure is baked for 60 minutes at about 200° C., forming red color filter layers R.

Similarly, green color filter layer G and blue color filter layer B are formed, using photosensitive resists in which green and blue pigment are dispersed, respectively. As a result, color filter layer CF having a thickness is 1.5 μm is formed.

Then, an ITO film is formed by sputtering to a thickness of about 0.1 μm. Photolithography is performed on the ITO film, thus providing pixel electrodes 151. Photosensitive black resin is applied by a spinner to the resulting structure, forming a resin film. The resin film is dried at about 90° C. for 10 minutes, forming a photomask. Ultraviolet rays are applied through the photomask to the peripheral part of each spacer 20, at a dose of about 300 mJ/cm². The acquired structure is developed with alkaline aqueous solution (pH=11.5). The structure is baked for 60 minutes at about 200° C. Patterning is thereby performed, forming spacers 20 and frame area 21.

On the counter substrate 102, a common electrode 22 made of ITO is formed by sputtering. Then, photosensitive resin resist is applied to the entire surface of the structure by means of a spinner. The resist is patterned, forming a photomask. The structure is exposed to light through the photomask and then developed. Ridge-shaped projections 30 are thereby formed. At the same time, superposed parts 34 are formed on those part of the counter substrate 102 which correspond to the spacers 20, by broadening the inclination correction parts 30B of the ridge-shaped projections 30.

Thereafter, an orientation film 19 about 70 nm thick is formed on the array substrate 101 and the counter substrate 102. The film 19 can orient liquid crystal molecules in vertical direction. The sides of the array substrate 101 are aligned with those of the counter substrate 102, by using a jig. The substrates 101 and 102 are bonded to each other with adhesive 25 made of epoxy-based thermosetting resin. Then, liquid crystal exhibiting negative dielectric anisotropy is injected into a cell through an injection port, filling the cell with the liquid crystal material. The injection port is sealed with ultraviolet-curable resin. Polarizing plates PL1 and PL2 are bonded to the substrates 101 and 102. Thus, a liquid crystal display panel 100 is manufactured.

In the liquid crystal display panel 100, ridge-shaped projections 30 are formed on the counter substrate 102, in order to control the orientation of the liquid crystal molecules. In the process of aligning the counter substrate 102 with the array substrate 101, the ridge-shaped projection 30 is prevented from interfering with the spacers 20. The liquid crystal display panel 100 can therefore be inexpensive and can yet have a large angle of visibility, sufficient cell-gap uniformity and no surface roughness, and can therefore display high-quality images.

The superposed parts 34 formed by broadening the inclination correction parts 30B are provided at the opposing outer edges of the electrodes 115 of two adjacent pixels, e.g., pixel PX1 and pixel PX2. The spacers 20 are arranged on the superposed parts 34. This greatly increases the cell-gap uniformity. As a result, the display panel 100 can have both high transmittance and high display quality, unlike the conventional liquid crystal display panel.

In the above-mentioned embodiment, the inclination correction part 30B and the superposed part 34 constitute an integral unit. Therefore, a of forming the superposed parts 34 need not be performed in manufacturing the liquid crystal display panel 100. Further, the blank area BL need not be so large as to prevent the spacers 20 from interfering with the ridge-shaped projections 30. The liquid crystal display panel 100 can therefore be inexpensive and can yet have high transmittance.

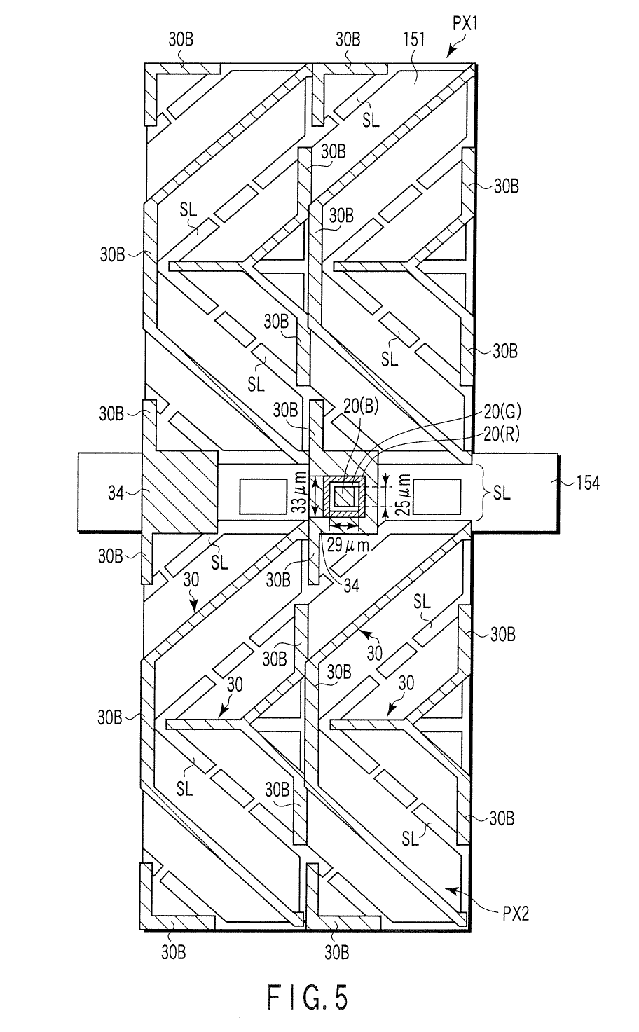

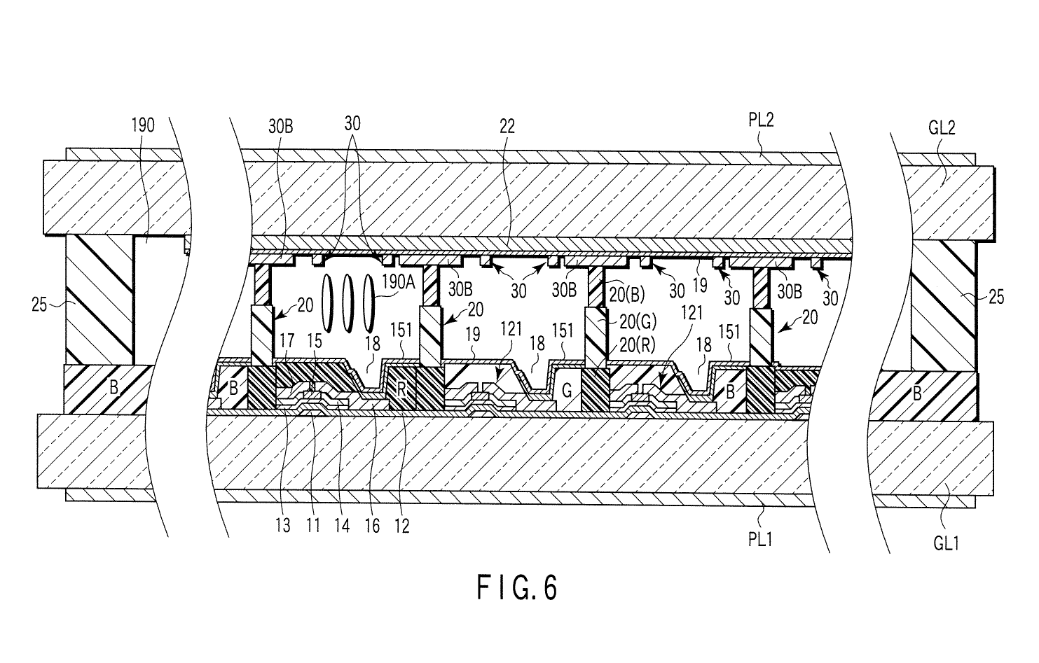

A second embodiment of this invention will be described. FIGS. 5 and 6 are, respectively a plan view and sectional view of the liquid crystal display panel 100 according to the second embodiment. The components identical to those of the first embodiment are designated at the same reference numbers and will not be described in detail.

As shown in FIGS. 5 and 6, spacers 20 are made of some parts of the color filter layers in the present embodiment. That is, the spacers 20 are made of the same material as color filter layers R, G, and B. The spacers 20 are formed by laying a red filter layer 20R (first color layer, size: 33×33 μm), a green filter layer 20G (second color layer, size: 29×29 μm) and a blue filter layer 20B (third color layer, size: 25×25 μm) that are laid one on another. A frame area 21 is formed at the same time as the blue filter layer B that has high light-shielding property.

The liquid crystal display panel 100 according to the second embodiment is differs from the first embodiment, only in the type of a photomask used to form the color filter layer CF because of the above-mentioned features. It is manufactured in the same way as the first embodiment and has the same configuration as the first embodiment.

Like the first embodiment, the second embodiment is an inexpensive liquid crystal display panel that can display images in high resolution, because the spacers 20 do not interfere with the ridge-shaped projections 30 and a large angle of visibility is acquired. Further, high cell-gap uniformity is attained because the array substrate 101 and the counter substrate 102 are well aligned with each other. As a result, the liquid crystal display panel 100 can achieve both high transmittance and high display quality, which is impossible with the conventional liquid crystal display.

In liquid crystal display panel 100 according to this embodiment, the spacers 20 can be thinner than in the conventional display panel, by the height of ridge-shaped projections. Therefore, the thickness of each of color filter layer can be thinner. So, the transmittance can therefore be improved.

The first and second embodiments were evaluated in comparison with Comparative Examples 1 and 2. The results will be described below.

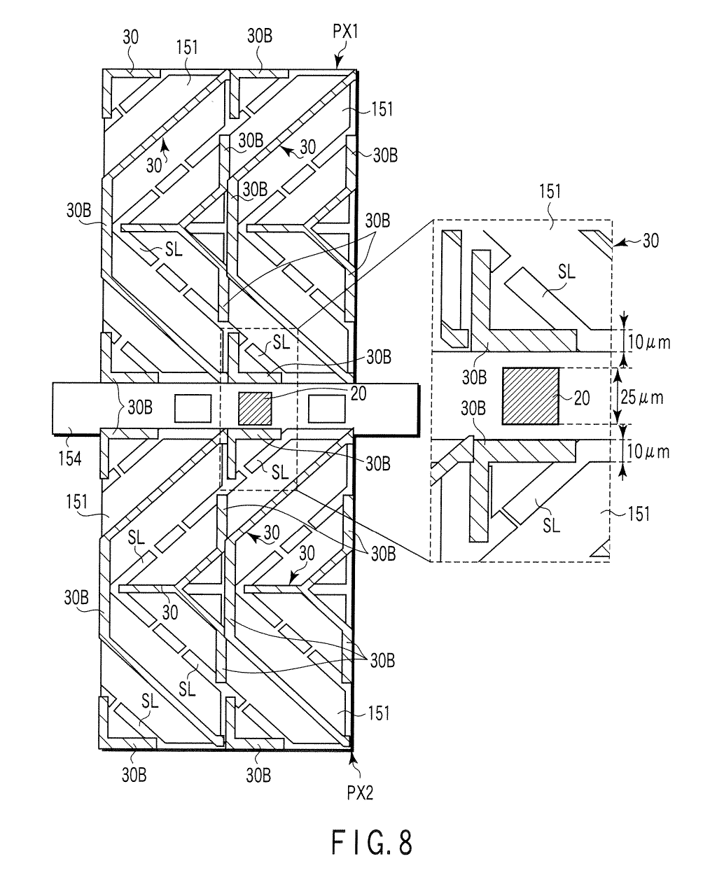

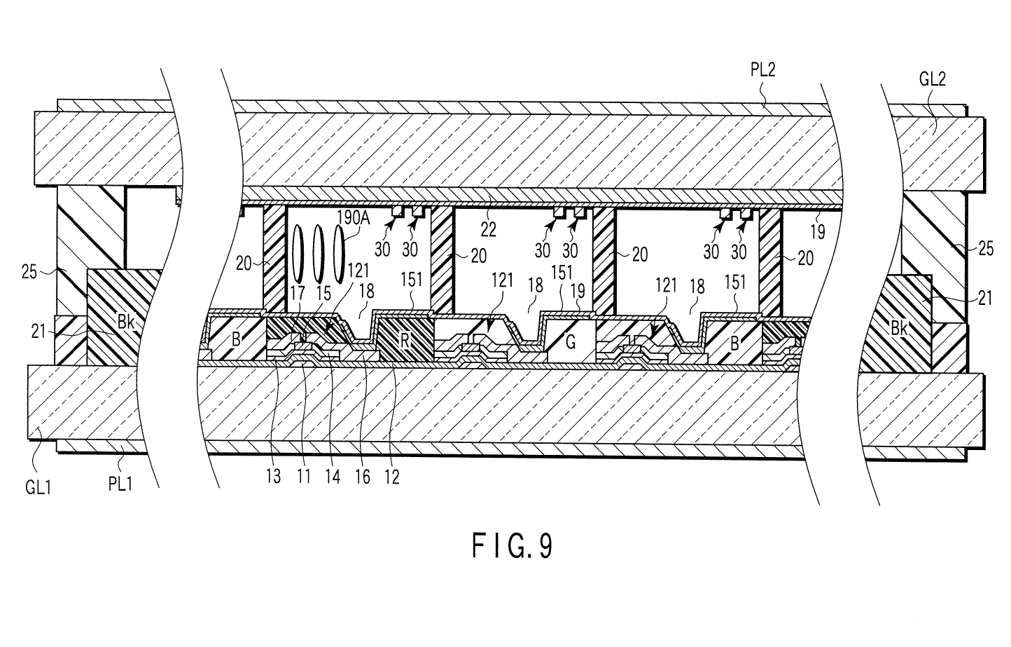

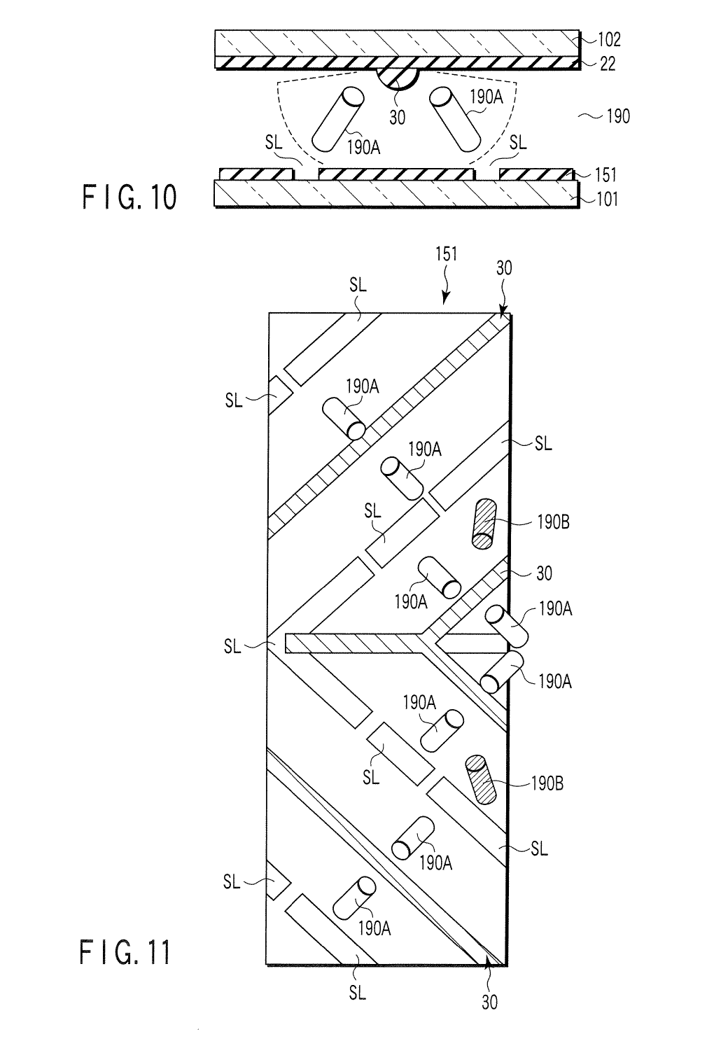

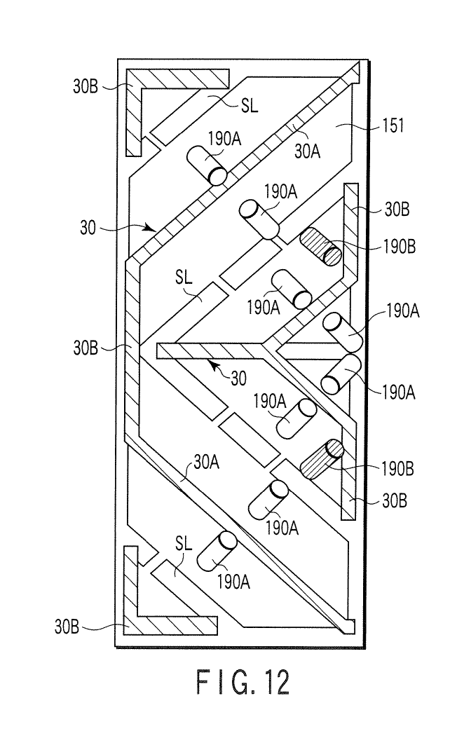

FIGS. 8 and 9 are, respectively, a plan view and sectional view of the liquid crystal display panel 100 of Comparative Example 1. In Comparative Example 1, inclination correction parts 30B are provided for any two adjacent pixels PX1 and pixel PX2, to prevent reverse orientation. The inclination correction parts 30B have a width of 10 μm. The inclination correction parts 30B are not integrally formed with superposed parts 34. The spacer 20 have the same size as in the first embodiment, i.e., 25×25 μm.

This liquid crystal display panel 100 is similar to the first embodiment in terms of configuration. It has been manufactured in the same way as first embodiment, except the type of the photomask used to form ridge-shaped projections 30.

In Comparative Example 2, the inclination correction parts 30B formed on pixel PX1 and pixel PX2, respectively, have a width of 7 μm. No superposed parts 34 are provided. The distance between each spacer 20 and the corresponding inclination correction part 30B is about 5.5 μm, longer than the distance of 2.5 μm in the first embodiment. Except for these points, Comparative Example 1 has been made by the same method as the first embodiment.

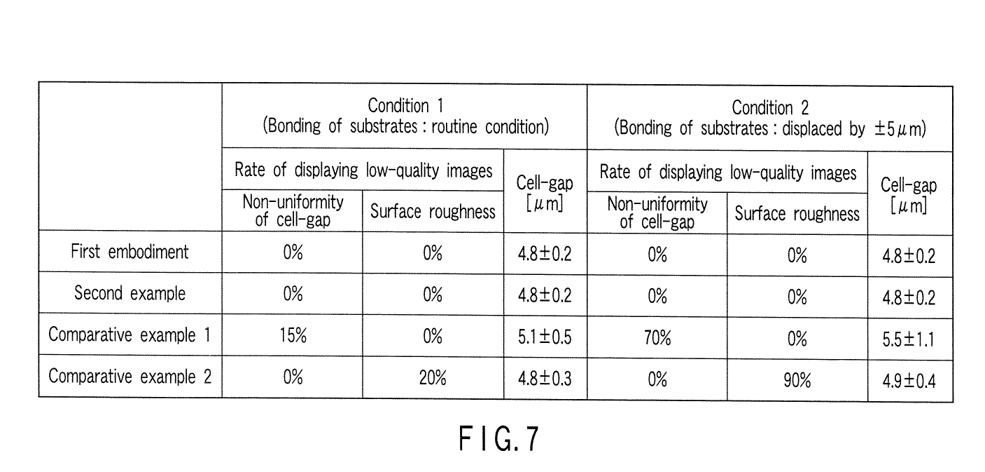

The results of evaluation of Comparative Examples 1 and 2, the first embodiment, and the second embodiment were as shown in FIG. 7.

As seen from FIG. 7, the liquid crystal display panel 100 according to the first embodiment exhibited good display quality. No reverse orientation was observed at either end of any pixel electrode 151. The liquid crystal molecules 190A were well oriented. In nine points, the cell gap was measured at nine points in the plane of the array substrate 101. The average cell gap was 4.8±0.2 μm against the design cell gap of 4.8 μm. Thus, high uniformity of cell-gap was achieved.

Further, two substrates, i.e., array substrate 101 and counter substrate 102, were displaced by ±5 μm and bonded to each other, thus manufacturing a liquid crystal display panel according to this invention. This display panel exhibited high uniformity of cell-gap, too, even though the array substrate and the counter substrate were displaced. This proves that the mutual displacement of the substrates is sufficiently compensated for, in the liquid crystal display panel according to this invention.

The spacers were analyzed for their cross-section shape by means of an SEM. The spacers of Comparative Example 1 were inversely tapered, while the spacers of the first embodiment were not tapered. This is because the black resin layer for spacers is thinner by the height of the ridge-shaped projections. Since the black resin layer is so thin, the spacers can be more easily formed than otherwise.

The second embodiment was examined to see how the liquid crystal molecules were oriented. No reverse orientation was observed, as in the first embodiment. Two substrates were intentionally displaced by ±5 μm and array substrate 101 and counter substrate 102 were bonded together. The liquid crystal display panel 100 thus manufactured had high uniformity of cell-gap and high display quality.

Further, in the second embodiment, each color layer was thinner by the height of the ridge-shaped projections, than in the conventional liquid crystal display panel in which the color filter layers are spaced apart by spacers. Therefore, it had higher transmittance than the conventional liquid crystal display panel.

In Comparative Example 1, the average cell-gap between the array substrate 101 and the counter substrate 102 was 5.1 μm, 0.3 μm greater than the design value of 4.8 μm. The cell-gap uniformity was lower than in the first and second embodiments of this invention.

A liquid crystal display panel 100, in which the array substrate 101 and the counter substrate 102 were displaced by in ±5 μ and then bonded together, had lower cell-gap uniformity. This was visually recognized as cell-gap unevenness of 70%.

Comparative example 2 was improved over Comparative Example 1 in terms of cell-gap uniformity. However, display-error rate was about 20%. The errors were examined for their cause. The inclination correction parts 30B, which should be essentially superimposed on the end parts of the pixel electrodes 151 were displaced, extending into the pixel electrodes 151, resulting in reverse orientation. The reverse orientation was recognized as surface roughness of the display screen.

With a liquid crystal display panel 100, in which the substrate 101 and the counter substrate 102 were intentionally displaced by ±5 μm and then bonded together, surface roughness was observed on about 90% of the display screen. The cell-gap uniformity of this display panel 100 was inevitably low.

As indicated above, each inclination correction part 30B is broad at the outer edges of two adjacent adjoining pixel electrodes 151 and a superposed part 34 is integrally formed with the inclination correction part 30B. Further, each superposed part 34 contacts the upper part of the corresponding spacer 20. Hence, the influence of the mutual displacement of the substrates, which takes place when the substrates are bonded together, can be reduced

In the MVA liquid crystal display element, wherein each pixel PX has an inclination correction part 30B on a line, such as an auxiliary capacity line 154, the spacers 20 and the inclination correction part 30B do not exist in high density within a small space. Therefore, it is not necessary to space each spacer 20 from the corresponding inclination correction part 30B by a distance long enough to provide a positioning margin. Nor is it necessary to make the spacers 20 smaller or to make the inclination correction parts 30B narrower.

As a result, the cell-gap uniformity increases, and the uniformity of display quality over the display screen increases, too. In addition, the design freedom greatly increases with respect to the size and position for the spacers 20 and inclination correction parts 30B.

The height of spacer 20 can be reduced by providing the superposed parts 34 on the spacers 20. Thus, the photolithography can be efficiently performed on the black material to form the spacers 20. In addition, the coloring layer can be thinner because of the small height of the spacers 20.

As a result, a liquid crystal display element that has good display characteristics can be provided at a low cost.

The present invention is not limited to the embodiments described above. Any components of the invention can be modified without departing the scope of the invention, if necessary at the time of reducing the invention to practice.

The embodiments described above are liquid crystal display panel that operate in MVA mode. Nonetheless, the present invention may be applied to liquid crystal display panels that operate in any other modes. In this case, too, the invention can achieves the same advantages as in the first and second embodiments described above.

Further, the components of any embodiment described above may be combined, in an appropriate manner, with those of any other embodiment, thereby making various inventions. For example, some of the components of any embodiment described above may not be used. Moreover, the components of one embodiment may be combined with those of any other component, in an appropriate manner.

For example, each superposed part 34 is integrally formed with two inclination correction parts 30B that are adjacent to a blank area BL. Instead, each superposed part 34 may be integrally formed with one inclination correction parts 30B. In this case, it is desired that the superposed part 34 should be formed in the entire blank area BL so that it may wholly contact the top of the spacer 20. Then, the same advantages can be attained as in the first and second embodiments.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A liquid crystal display panel comprising:
a first electrode substrate;
a second electrode substrate; and
a liquid crystal layer which contains a liquid crystal composition having negative dielectric anisotropy and which is interposed between the first electrode substrate and the second electrode substrate,
the first electrode substrate having a plurality of pixel electrodes which are spaced apart by blank areas, and a plurality of spacers which are arranged in the blank areas and which set the first and second electrode substrates apart from each other by a predetermined distance,
the second electrode substrate having a plurality of ridge-shaped projections which are opposed to said plurality of pixel electrodes and which control a inclination of an electric field applied between the first and second electrode substrates, and flat parts which are integrally formed with the ridge-shaped projections and which wholly contact tops of the spacers.

2. The liquid crystal display panel according to claim 1, wherein each of the pixel electrode has a plurality of slits, the slits are arranged, inclining at approximately 45° to sides of the first electrode substrate and having such anisotropy of approximately 90° with respect to the next slit; and each of the ridge-shaped projections has a inclination control part which extends substantially parallel to the slits and a inclination correction part which extends along a part of an outer edge of one pixel electrode.

3. The liquid crystal display panel according to claim 2, wherein the flat parts are integrally formed with the inclination correction parts.

4. The liquid crystal display panel according to claim 1, wherein the first electrode substrate further has a frame area surrounding said plurality of pixel electrodes and a shielding layer provided in the frame area, and the spacers are made of the same material as the shielding layer.

5. The liquid crystal display panel according to claim 1, wherein the first electrode substrate further has a cooler filter layer consisting of a plurality of color layers arranged, and the spacers are formed of a part of the color filter layer.
